(19) United States
(12) Patent Application Publication
(10) Pub. No.: US 2006/0265196 A1
(43) Pub. Date: Nov. 23, 2006

(54) Method of apartment design

(76) Inventor: R. Jerry Stone JR., Dallas, TX (US)

Correspondence Address: Michael A. O'Neil;Michael A. O'Neil, P.C., Suite 820, 5949 Sherry Lane, Dallas, TX, 75225, US

(21) Appl. No.: 11/134,115

(22) Filed: May 19, 2005

(51) Int. Cl. G06F 17/50

(52) U.S. Cl. 703/1

(57) ABSTRACT

A basic floor plan includes basic components of an apartment home and provides the foundation for adding additional living space and more components without changing the basic components of the apartment or re-engineering the apartment building's structure or architectural lines.

### TECHNICAL FIELD

This invention relates generally to apartment construction and more particularly to an improved method of apartment design.

### BACKGROUND AND SUMMARY OF THE INVENTION

Apartment buildings typically offer numerous floor plans having differing amounts of living space. Once the architectural plans for a particular apartment building are established, the number of available floor plans comprising the apartment building is fixed. If apartments having more overall living space are required, or if apartments having less overall living space are required, or if the number of apartments comprising the apartment building is changed, the architectural plans for the apartment building must be redrawn to accommodate the new or alternative apartment designs. As a result, significant time delays and cost overruns are incurred.

The present invention comprises a novel method of apartment design which overcomes the foregoing and other difficulties which have long since characterized the prior art. In accordance with the broader aspects of the invention, there is provided a set of predetermined apartment design components. The various apartment designs comprising the apartment building differ from one another in terms of overall living space; however, each of the floor plans comprising the apartment building includes an identical set of predetermined apartment design components. In this manner changes in the design of the apartment building to accommodate apartment designs comprising more overall living space, or less overall living space, or to accommodate a change in the total number of apartments can be accomplished in minimal time and at minimal expense.

In accordance with more specific aspects of the invention, the set of predetermined apartment design components includes a kitchen component, a bathroom component, a laundry room component, a living room component, and a dining room component. In the case of apartment designs having larger amounts of overall living space, the bathroom component comprising the set may be duplicated. The orientation of the apartment design components relative to one another within a particular apartment design is variable to accommodate the requirements of each apartment design.

### BRIEF DESCRIPTION OF THE DRAWINGS

A more complete understanding of the present invention may be had by reference to the following Detailed Description when taken in connection with the accompanying Drawings, wherein:

FIG. 1 is an illustration of a basic one bedroom floor plan incorporating the method of the present invention;

FIG. 2 is an illustration of a two bedroom floor plan incorporating the method of the present invention;

FIG. 3 is an illustration of a larger two bedroom floor plan incorporating the method of the present invention; and

FIG. 4 is an illustration of a three bedroom-floor plan incorporating the method of the present invention.

### DETAILED DESCRIPTION

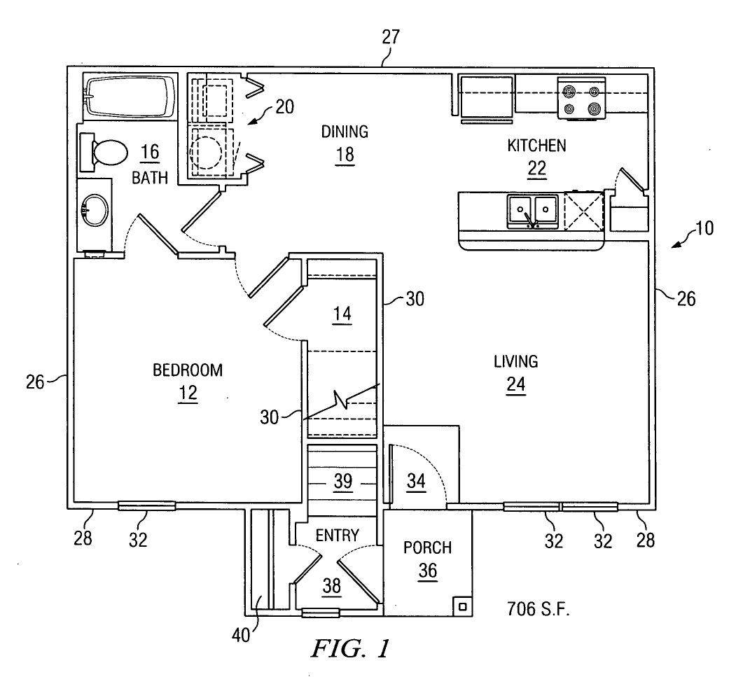

Referring now to the Drawings, and particularly to FIG. 1, there is shown a basic one bedroom floor plan 10 incorporating the design method present invention. The one bedroom floor plan 10 provides 706 square feet of living space and comprises a plurality of basic apartment home components including a first bedroom 12, a closet 14, a bathroom component 16, a dining room component 18, a laundry room component 20, a kitchen component 22, and a living room component 24. Two side walls 26, a back wall 27, front walls 28, and interior walls 30 comprise the primary structural walls of the one bedroom floor plan 10. The side walls 26 do not have windows or entryways thereby allowing the side walls 26 to function either as common walls between an adjacent unit or the exterior walls of the building. The front walls 28 comprise windows 32, an entry 34, and a porch 36. The floor plan 10 utilized in conjunction with a second level apartment will further comprise a ground level entry 38 into a stairway 39 in place of the entry 34 and a closet 40 located above the ground level entry 38 and porch 36. Although the floor plan 10 shown provides 706 square feet of living space, the dimensions may be altered to adjust square footage.

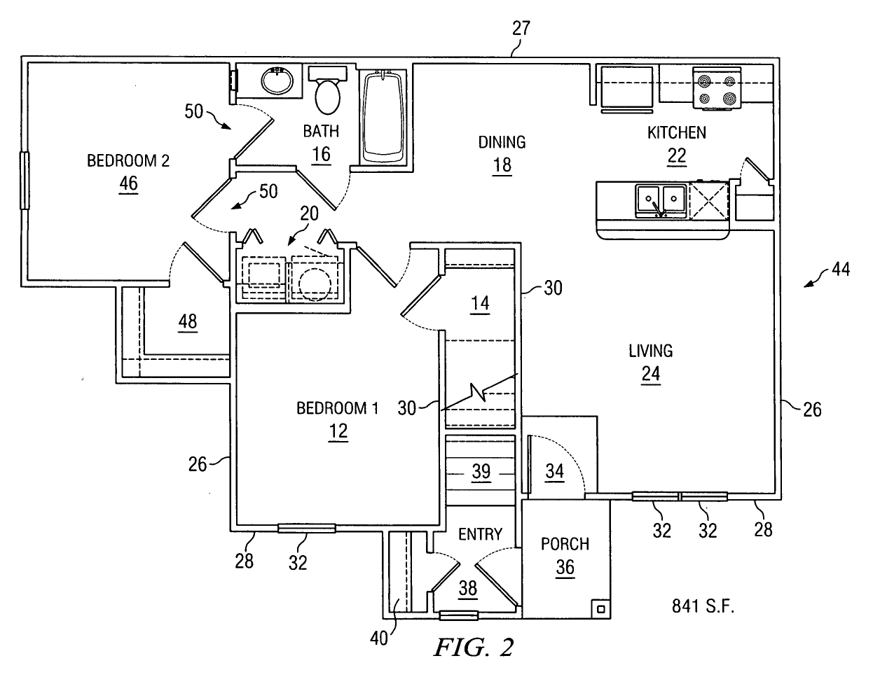

FIG. 2 illustrates a two bedroom floor plan 44 incorporating the design method of the present invention. The two bedroom floor plan 44 has the same basic layout of the one bedroom floor plan 10 of FIG. 1, but provides 841 square feet of living space and has additional components added thereto. A second bedroom 46 and a closet 48 are added with minimal changes to the basic components or primary structural walls of the floor plan 10 of FIG. 1. The only changes required to be made to the floor plan 10 of FIG. 1 is to cut two doorways 50 into the side wall 26 adjacent to the first bedroom 12 and reconfiguring the location and orientation of the bathroom component 16 and laundry room component 20. Otherwise, the bathroom component 16, the laundry room component 20, the kitchen component 22, the living room component 24 are identical and the dining room component 18 is substantially identical to the like-numbered components of the apartment design shown in FIG. 1 and described hereinabove and in conjunction therewith. Although the floor plan 44 shown provides 841 square feet of living space, the dimensions may be altered to adjust square footage.

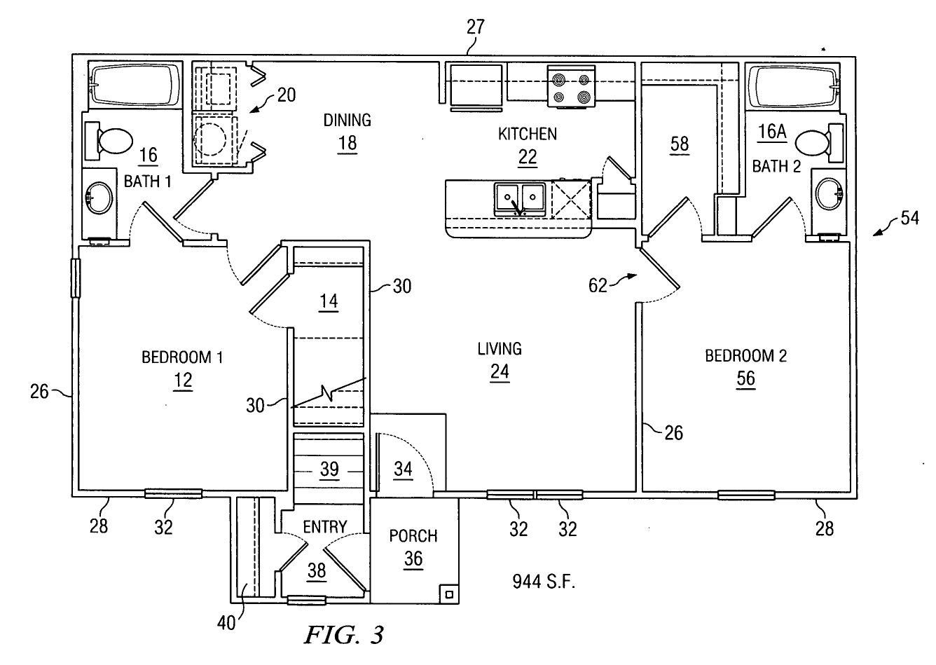

FIG. 3 illustrates a larger two bedroom floor plan 54 incorporating the design method of the present invention. The larger two bedroom floor plan 54 has the same basic layout of the one bedroom floor plan 10 of FIG. 1, but provides 944 square feet of living space and comprises a second bedroom 56, a closet 58, and a second bathroom component 16A. The additional bedroom 56, the closet 58, and the bathroom component 16A are added with minimal changes to the basic components or primary structural walls of the floor plan 10 of FIG. 1. The only change required to be made to the floor plan 10 of FIG. 1 is cutting a doorway 62 into the side wall 26 adjacent to the living room component 24. The second bathroom component 16A is a reverse orientation of the first bathroom component 16. Otherwise, the bathroom component 16, the laundry room component 20, the kitchen component 22, the living room component 24, and the dining room component 18 is identical to the like-numbered components of the apartment design shown in FIG. 1 and described hereinabove and in conjunction therewith. Although the floor plan 54 shown provides 944 square feet of living space, the dimensions may be altered to adjust square footage.

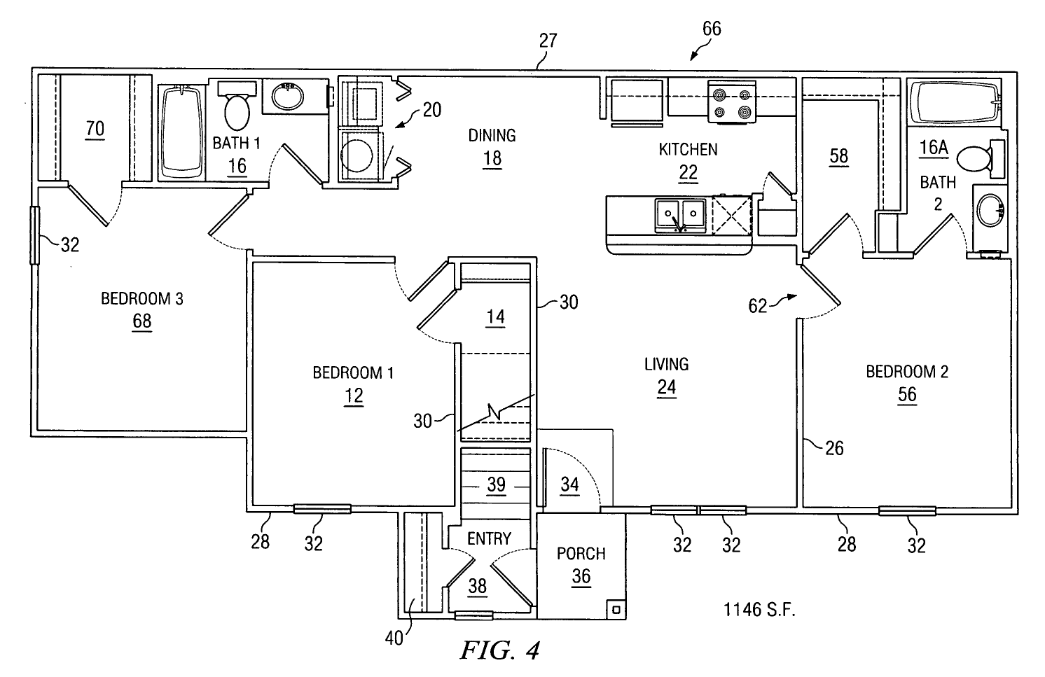

FIG. 4 illustrates a three bedroom floor plan 66 incorporating the design method of the present invention. The three bedroom floor plan 66 incorporates the larger two bedroom floor plan 54 having the same basic layout of the one bedroom floor plan 10 of FIG. 1 and provides a third bedroom 68 and a closet 70, resulting in 1146 square feet of living space. Some change to the side wall 26 adjacent to the first bedroom 12 is required and the location and orientation of the first bathroom component 16 must be reconfigured to make way for access into the third bedroom 68, but no other changes to the larger two bedroom floor plan 54 are required. Otherwise, the bathroom component 16, the laundry room component 20, the kitchen component 22, the living room component 24, and the dining room component 18 is identical to the like-numbered components of the apartment design shown in FIG. 1 and described hereinabove and in conjunction therewith. Although the floor plan 66 shown provides 1146 square feet of living space, the dimensions may be altered to adjust square footage.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of apartment design comprising the steps of:
providing a set of predetermined apartment design components including a kitchen component, a bathroom component, and a laundry room component; and
providing at least three apartment designs each having a different total area than the others and each including the same set of predetermined apartment design components.

2. The method of apartment design according to claim 1 wherein the step of providing a set of predetermined components includes the step of providing a living room component.

3. The method of apartment design according to claim 1 wherein the step of providing a set of predetermined components includes the step of providing a dining room component.
